(19) United States
(12) Patent Application Publication
(10) Pub. No.: US 2014/0151300 A1
(43) Pub. Date: Jun. 5, 2014

(54) WATER TREATMENT PROCESS FOR HIGH SALINITY PRODUCED WATER

(71) Applicant: WATER & POWER TECHNOLOGIES, INC., Salt Lake City, UT (US)

(72) Inventors: Jeffrey D. Savage, Sandy, UT (US); Joseph C. Jimerson, Conroe, TX (US); Donald J. Thomas, Tooele, UT (US)

(73) Assignee: WATER & POWER TECHNOLOGIES, INC., Salt Lake City, UT (US)

(21) Appl. No.: 13/705,445

(22) Filed: Dec. 5, 2012

(51) Int. Cl. E21B 21/06; C02F 9/00

(52) U.S. Cl. CPC E21B 21/063; C02F 9/00
USPC 210/638; 210/641; 210/639; 210/202; 210/199; 210/195.2; 210/177

(57) ABSTRACT

Processes and systems for treating high salinity aqueous liquids containing dissolved minerals, suspended solids, colloidal solids, free oil and grease, dissolved organics, and dissolved hydrocarbons. The liquid is passed into an electrocoagulation system in fluid communication with a solids removal clarifier, pressurized ultrafiltration system, the draw side of forward osmosis, and a dilute draw water reverse osmosis system. Impaired water with high sulfate content is used as a source of deionized water for dilution of the forward osmosis draw solution. After concentration, the forward osmosis feed solution is further treated by lime soda softening and sludge from the softening system may be recycled to increase hardness precipitation and silica removal, the outfall from which may be treated by a separate ultrafiltration system and a feed water reverse osmosis system. Concentrate from the feed water reverse osmosis system can be treated to offer a zero liquid or near zero liquid discharge.

### TECHNICAL FIELD

The present disclosure relates to the removal of solutes from a high salinity aqueous solvent, more particularly, to the removal of solutes present in oil and gas produced water and hydraulic fracturing flow back water to a level sufficient to meet state and/or federal requirements for discharge and beneficial use of the treated water.

### BACKGROUND

Oil and natural gas demand increases have resulted in the increased use of unconventional methods of exploration and production. Directional drilling and hydraulic fracturing techniques have been developed and successfully employed to permit the economic recovery of oil and natural gas from known reserves that cannot be accessed by conventional means. Among the most productive unconventional resources are plays into shale that yield natural gas, gas condensates, and crude oil. Among the most successful plays in shale for these hydrocarbon resources are the North American formations such as the Rocky Mountain area that includes the Powder River Basin, Wind River Basin, and Greater Green River Basin in Wyoming, the Uintah Basin in Utah, the San Juan Basin in New Mexico, and the Piceance Basin and Denver Basin in Colorado. Other important areas for unconventional gas and oil plays into shale include the Utica, Horn River, Niobrara, Bakken, Woodford, Fayetteville, Eagle Ford, Marcellus, Haynesville, and Barnett formations.

The first commercial hydraulic fracturing for oil and gas production was performed by Halliburton on Mar. 17, 1949 in Stephens County, Okla. and Archer County, Tex. under a licensing agreement with Stanolind Oil. Fracture stimulation is known to increase the production rate of a well and adds to the known reserves, providing access to hydrocarbon resources previously unrealized. Combined with directional drilling into deep formations, this technique has resulted in oil and gas production in locations previously unproductive when drilled vertically using conventional methods.

Hydraulic fracturing requires a source of water since the fluids used are predominately water. Depending on the nature of the hydraulic fracturing fluid used the makeup water required can have a high quality requirement, often of a quality similar to drinking water. In other instances the makeup water can have a lower quality. A hydraulic fracturing of a single well can require on the average between two (2) million and four (4) million gallons of water for deep unconventional shale reservoirs. After hydraulic fracture stimulation is complete, the fracturing fluid flows back to the surface for a period of time. This flow back water often requires treatment for beneficial reuse or is often collected for disposal by deep well injection.

After the flow back period ends and the well is in production, the hydrocarbon that flows to the surface is accompanied by produced water from the formation that has to be treated or disposed of after it is separated from the oil or gas. In certain locations this produced water can have a very high concentration of dissolved solids, some formation or produced waters approaching near saturated concentrations of sodium chloride. The produced water can also contain high concentrations of dissolved organics, ammonia, boron, silica, alkaline earth metals (calcium, magnesium, barium, strontium), and other regulated solutes that prevent beneficial reuse of the water without treatment. In the current practice there is little alternative but to dispose of the produced water by deep well injection sometimes at 3,000 to 6,000 feet requiring significant energy cost to perform the pumping. Often the high salinity produced water has to be diluted with fresh water or flow back water before disposal by deep well injection. Operators will blend flow back water and the produced water before filtration and deep well injection as a usual practice.

In some locations, particularly in the Bakken formation areas of Eastern Montana and Western North Dakota, there are abundant sources of fresh water that are impaired due to a high concentration of sulfate. The high sulfate water can be found in shallow wells and is abundantly found in the well-studied Dakota Aquifer. The high sulfate impaired water is unable to be used as potable water, livestock water, irrigation water, or for hydraulic fracturing because of the sulfate concentration.

Given the challenges and cost of disposing high salinity produced water and flow back water, the scarcity of fresh water sources for the makeup of hydraulic fracturing fluid, and the existence of an impaired water high in sulfate concentration that has very limited beneficial use, particularly in areas such as the Bakken formation area, there is a need in the art for a water treatment method and system that economically removes at a high recovery the various solutes to concentrations that are acceptable for hydraulic fracturing, irrigation water use, livestock water use, or surface discharge under various state and/or federal regulations, completely above ground, eliminating or dramatically reducing the need for disposal by deep well injection as is currently practiced in the oil and gas industry.

### SUMMARY

The present disclosure includes methods and systems for treating an aqueous liquid containing dissolved minerals, free oil and grease, suspended solids, colloidal material, and dissolved hydrocarbons. In one illustrative embodiment, such a method may comprise passing a high salinity produced water containing dissolved minerals, free oil and grease, suspended solids, colloidal material, and dissolved hydrocarbons through an electrocoagulation system at an unadjusted pH. The effluent from the electrocoagulation system may then pass to a quiescence zone of an inclined plate or inclined tube style clarifier, and the clarifier effluent then passed through ultrafiltration and the draw solution side of a forward osmosis system prior to treatment by a reverse osmosis system. The high salinity produced water and flow back water may be diluted in the forward osmosis system by high purity deionized water drawn across a semi-permeable membrane at low pressure from a high sulfate impaired water of lower salinity which is used as a feed water source for the forward osmosis system. The concentrated feed water from the forward osmosis system may be further treated by lime soda softening for hardness and silica removal, and passed through a separate ultrafiltration system prior to treatment after pH adjustment as may be required by a second reverse osmosis system operating at high recovery.

In certain embodiments, the methods may further include one or more additional treatments for the concentrated feed water from the forward osmosis system: coarse filtration in fluid communication with a feed water storage tank; a lime soda softener relying on lime and sodium carbonate (soda ash) addition for silica and hardness removal (see U.S. Pat. Nos. 7,520,993 and 7,718,069) in liquid communication with an ultrafiltration process; recycling at least a part of a precipitate sludge produced by the lime soda softener back into the lime soda softener; passing the filtrate from the ultrafiltration process to a feed water reverse osmosis system collecting the permeate as pure water and further recovering water by treating the feed water reverse osmosis concentrate with an evaporator and crystallizer providing for a near zero or zero liquid discharge from the process; producing a discharge water meeting local irrigation water and surface water discharge regulations, combining the feed water reverse osmosis permeate with evaporator and crystallizer condensate; and combinations and alterations thereof.

In some embodiments, the methods may further include one or more of the following to treat draw water used for the forward osmosis system, which can be high salinity produced water, flow back water, reverse osmosis concentrate from treating the diluted draw water, either alone or in combination: an electrocoagulation system based on the patented technology of Scott Wade Powell (see U.S. Pat. Nos. 8,048,279; 7,758,742; 7,211,185; 6,488,835; 6,139,710; and 8,133,382) for the removal of suspended solids, colloidal solids, dissolved hydrocarbons, free oil and grease, silica, and dissolved organics in liquid communication with an inclined plate, inclined tube, or solids contact clarifier; passing the outfall from the clarifier to a pressurized ultrafiltration system that has liquid communication with a draw solution storage tank from which the draw solution is fed to the forward osmosis system; the draw solution being a combination of the electrocoagulated, clarified, and ultrafiltered high salinity produced water and concentrate from a diluted draw reverse osmosis system; passing a diluted draw solution to a reverse osmosis system collecting the permeate as pure water; producing a high purity discharge water meeting local irrigation and surface water discharge regulation combined with the feed water reverse osmosis permeate and evaporator and crystallizer condensate; and combinations and alterations thereof. Adjustment of pH prior to a draw water reverse osmosis system and the addition of a calcium salt such as calcium chloride into the combined pure water discharge may be done to meet Sodium Adsorption Ratio (SAR) and pH discharge regulations. Further boron removal if required from the high purity discharge water may be accomplished by boron selective ion exchange.

In other illustrative embodiments, the system for treating an aqueous liquid solution containing dissolved minerals, free oil and grease, suspended solids, colloidal solids, and dissolved hydrocarbons comprises passing high salinity produced water containing dissolved minerals, free oil and grease, suspended solids, colloidal solids, and dissolved hydrocarbons, or a waste water stream, through an electrocoagulation system, may use an electrocoagulation system that includes a reaction basin with a set of spaced reaction plates where an electrical voltage is applied to selected reaction plates that are vertically arranged to create an electric field within the reaction chamber and the voltage and amperage of the electric field may be adjusted by the selective placement of reaction plates in electrical contact with a voltage source. The reaction plates may be constructed of carbon steel or aluminum or a combination of both carbon steel and aluminum, or other suitable material, and the electrocoagulation treatment may take place with unadjusted pH. The outfall from the electrocoagulation reaction chamber may pass to the quiescence zone of an inclined plate or inclined tube style clarifier, and the clarifier effluent may be passed through a pressurized ultrafiltration system and the draw solution side of a forward osmosis system prior to treatment by a diluted draw solution reverse osmosis system. The high salinity produced water and flow back water may be diluted in the forward osmosis system by a high purity deionized water drawn across a semi-permeable membrane at low pressure from the high sulfate impaired water of lower salinity used as a feed source for the forward osmosis system. The concentrated feed water from the forward osmosis system may be further treated by lime soda softening at ambient temperature for hardness and silica removal, passing through a separate ultrafiltration system prior to treatment by a feed water reverse osmosis system operating at high recovery.

### BRIEF DESCRIPTION OF THE DRAWINGS

The following drawings illustrate exemplary embodiments in accordance with the present disclosure. Like reference numerals refer to like parts in different views or in different drawings.

FIG. 1 is a flow chart of a process for water treatment according to a first illustrative embodiment in accordance with the principles of the invention.

FIG. 2 is a flow chart of one illustrative process for pretreatment for produced water and flow back water used as a draw solution or osmolyte for forward osmosis that may be used with the process of FIG. 1.

FIG. 3 is a flow chart of one illustrative process for post-treatment of an impaired water after concentration of the feed solution by forward osmosis that may be used with the process of FIG. 1.

FIG. 4 is a flow chart of one illustrative process for purifying diluted draw solution from forward osmosis that may be used with the process of FIG. 1.

### DETAILED DESCRIPTION

The present disclosure relates to processes, systems, and methods for treating high saline produced water or similar waste water. It will be appreciated by those skilled in the art that the embodiments herein described, while illustrative, are not intended to so limit the invention or the scope of the appended claims. Those skilled in the art will also understand that various combinations or modifications of the embodiments presented herein can be made without departing from the scope of the invention. All such alternate embodiments are within the scope of the present invention. Similarly, while the drawings may depict illustrative embodiments of processes, devices, and components in accordance with the present invention and illustrate the principles upon which the system is based, they are only illustrative and any modification of the features presented herein are to be considered within the scope of the present invention.

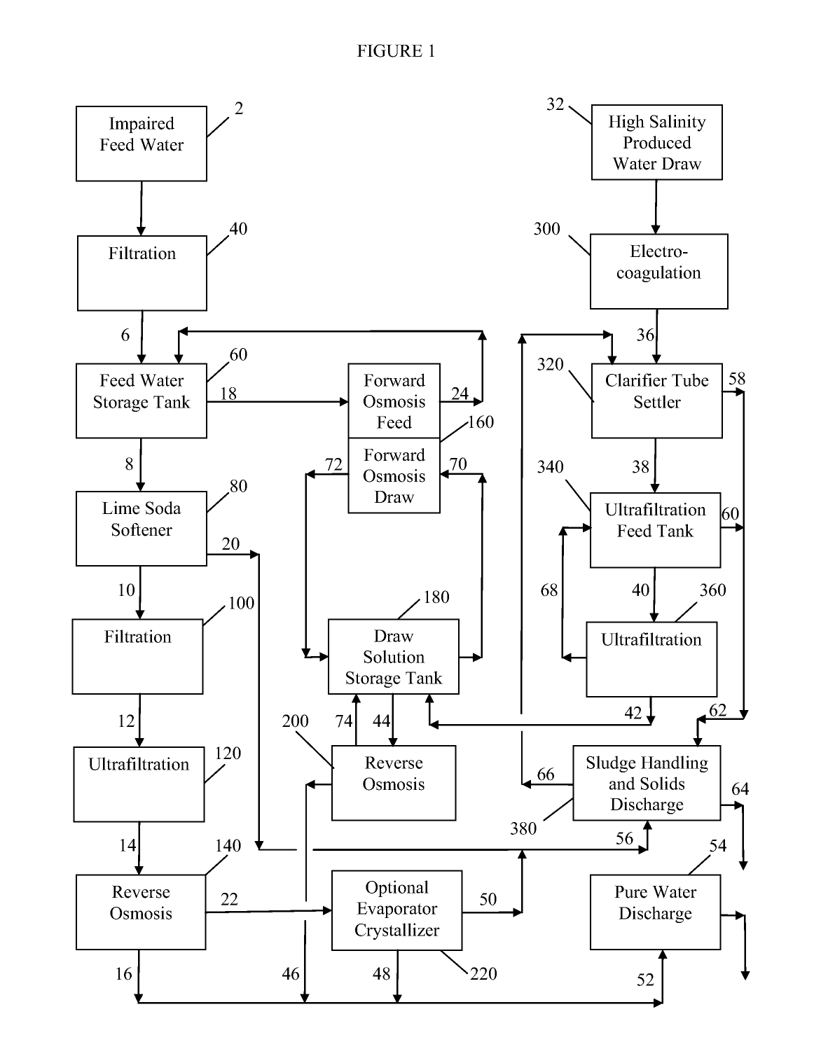

Referring to FIG. 1, the high salinity produced water and flow back water from hydraulic fracturing undergoes oil and gas separation to produce the high salinity produced water indicated at 32, which is treated by electrocoagulation 300 and the outfall from the electrocoagulation system enters an inclined plate, inclined tube, or solids contact clarifier, such as clarifier tube settler 320 as indicted at 36, which serves to separate the flocculation and coagulation solids from the electrocoagulated water. The solids settled in the clarifier are removed as a sludge slurry, as shown at 58, while the clarifier effluent is pumped to the ultrafiltration feed tank 340, as shown at 38. The ultrafiltration system 360 may be fed in a cross flow pattern with the ultrafiltration feed water as shown at 40, which may be recirculated back to the ultrafiltration feed tank 340, as shown at 68. Solids that accumulate in the ultrafiltration feed tank 340 may be removed as a sludge slurry, as indicated at 60, and may be combined with the clarifier sludge indicated at 58 to form a combined sludge stream, as shown at 62, that is managed in a sludge handling and solids discharge system 380. The water from the sludge handling system may be recovered back to the clarifier 320, as shown at 66. The ultrafiltration filtrate is collected in the forward osmosis draw solution storage tank 180, as shown at 42.

One suitable ultrafiltration membrane which can be used for the ultrafiltration 360 is a fouling resistant spiral wound ultrafiltration membrane available from by Hydration Technology Innovations under the trade name and model Sepramem 8040 UF-CS, which includes a hydrophilic proprietary hydrolyzed cellulose ester membrane material and a 100 mil (0.100″) corrugated feed spacer. It will be appreciated that other suitable membranes having the appropriate properties may also be used. The electrocoagulation system 300 in combination with the clarifier 320 and ultrafiltration system 360 targets an elimination of suspended solids, colloidal solids, dissolved organics, dissolved hydrocarbons, and free oil and grease that are present in the produced water and flow back water being treated.

Referring further to FIG. 1, forward osmosis 160 is used to treat the collected draw solution by feeding impaired feed water 2 into filtration 40, such as disc filtration or similar filtration technology before it is used as a forward osmosis feed for forward osmosis 160. One suitable forward osmosis membrane used is the Osmem Model 8040 FO CTA MS-P-M manufactured by Hydration Technology Innovations, although it will be appreciated that similar products and any suitable membrane may be used. Such membranes have low fouling tendencies and may be manufactured in a spiral wound configuration from cellulose triacetate material. Some examples are described in U.S. patent application Ser. Nos. 12/965,874 and 12/720,633 and U.S. Pat. No. 4,033,878, the disclosures of which are incorporated by reference herein. Forward osmosis 160 uses an impaired feed water high in sulfates or other contaminants after filtration 40 and storage 60 as a source of pure water after it is drawn across a semi-permeable membrane, as shown at 18, diluting the draw solution drawn from the draw solution storage tank 180 and shown at 70, and which is recirculated back to the draw solution tank 180 as shown at 72. The feed water is concentrated as it is recirculated back to the feed water storage tank 60, as indicated at 24. The concentrated feed water may be further treated by a lime soda softener 80, as indicated at 8 and the softener outfall filtered by disc filtration 100, as shown at 10, and ultrafiltration 120, as shown at 12, before the ultrafiltration filtrate is further treated at high recovery by reverse osmosis 140, as indicated at 14. The feed water reverse osmosis system 140 permeate may be collected as a pure water for discharge 54, as shown at 16. The feed water reverse osmosis system permeate shown at 16 may be blended with the diluted draw solution reverse osmosis system 200 permeate shown at 46 and any distillate from an optional evaporator and crystallizer 220 (where present) as shown at 48.

The lime soda softener 80 has sludge slurry that may be processed in the sludge handling and solids discharge system 64. As indicated at 20, the lime soda softener 80 sludge slurry may be combined with the crystallized solids from the optional evaporator and crystallizer 220, as indicated at 50, to provide for a common feed shown at 56 to the sludge handling and solids discharge 300.

Referring further to FIG. 1, the forward osmosis 160 draw solution shown at 70 becomes diluted with deionized water drawn from the feed solution and the diluted draw solution is passed to the reverse osmosis system 200, as shown at 72. The permeate from the reverse osmosis system 200 may be collected as indicated at 46 as pure water for discharge as indicated at 54 and may be blended with the feed water reverse osmosis permeate shown at 16 and the distillate from the optional evaporator and crystallizer (where present) shown at 48 to form a common pure water stream, as indicated at 52. The concentrate from the draw solution reverse osmosis system 200 may be recycled back to the draw solution storage tank 180, as shown at 74.

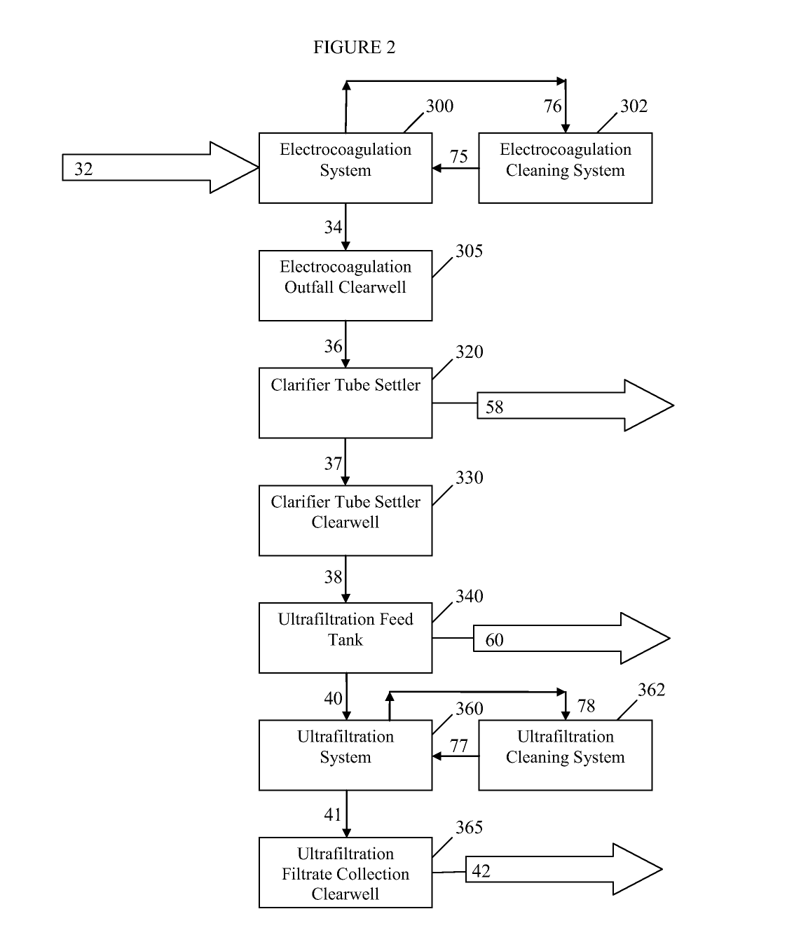

FIG. 2 illustrates one process for pretreatment of the high saline produced water and flow back water indicated at 32 where the electrocoagulation system 300 is designed to include a cleaning system 302. In such a process, a dilute hydrochloric acid based cleaning solution is fed to the electrocoagulation system 300, as shown at 75, and returned to the electrocoagulation cleaning system 302, as shown at 76. It will be appreciated that the periodic cleaning may be conducted at suitable intervals based on the specific application of the system and the contaminants present in the water 32. The electrocoagulation system 300, the inclined plate, inclined tube or solids contact clarifier 320, and the ultrafiltration system 360 are all designed to include clearwells 305, 330, 365. Treated water from these processes indicated at 34, 37, 41 may be pumped as required to the next process step indicated at 36, 38, 42, respectively. The ultrafiltration system 360 may include a cleaning system 362 that permits the periodic cleaning of the membrane filtration system by feeding a cleaning solution, as shown at 77, which may be recirculated back to the cleaning system 362, as shown at 78.

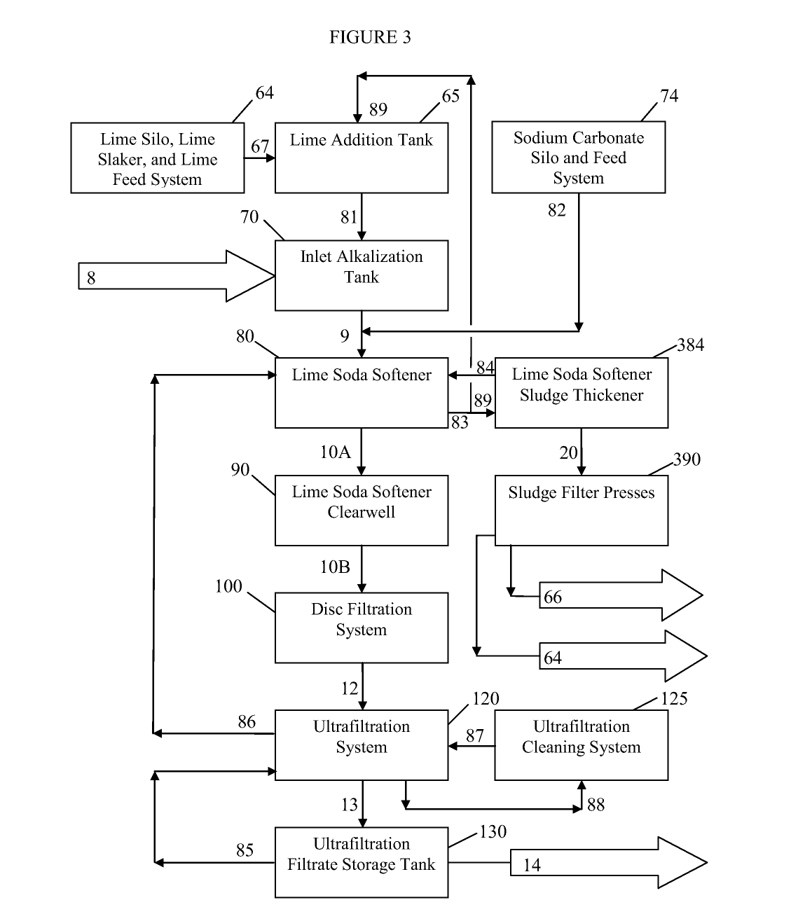

FIG. 3 illustrates one process for treatment of the concentrated feed solution indicated at 8 from the forward osmosis system (FIG. 1; Item 160). The lime soda softener system includes a lime silo, lime slaker, and lime feed system generally indicated at 64, a sodium carbonate (soda ash) silo and feed system generally indicated at 74, which are in fluid communication with a lime soda precipitation softener vessel 80. In one exemplary embodiment, the lime soda softener system comprises a lime silo, lime slaker, and lime feed system 64 in fluid communication indicated at 67 with a lime addition tank 65, which in turn is in fluid communication, indicated at 81, with an inlet alkalization tank 70 into which the lime, a carrier indicated at (such as sludge recycled from the lime soda precipitation softener vessel 80 and/or sludge storage tank 384) and concentrated feed water 8 are mixed. Recycling the sludge from the lime soda precipitation softener 80 into the lime addition tank 65 as indicate at 89 can promote particle growth, and improve the removal of suspended solids and colloidal and dissolved silica. The sludge may then be dewatered, for example, by sending the sludge to filter presses 390, as indicated at 20, and the solid waste 64 disposed of by methods known in the art. The outfall from the lime soda softener 80 may be further treated by filtration 100 and ultrafiltration 120, where the ultrafiltration backwash water or any cross flow concentrate required for maintenance are recovered back through the lime soda softener 80, as indicated at 85 and 86. The concentrated feed water ultrafiltration system 120 may be based on use of a hollow fiber module with an inside-to-outside flow configuration with PVDF membranes. One example is the Dow Model SFP-2880 product. The ultrafiltration system 120 may be in fluid communication with a cleaning system 125 that permits the periodic cleaning of the membrane filtration system by feeding a cleaning solution, as shown at 87, that can be recirculated back as shown at 88.

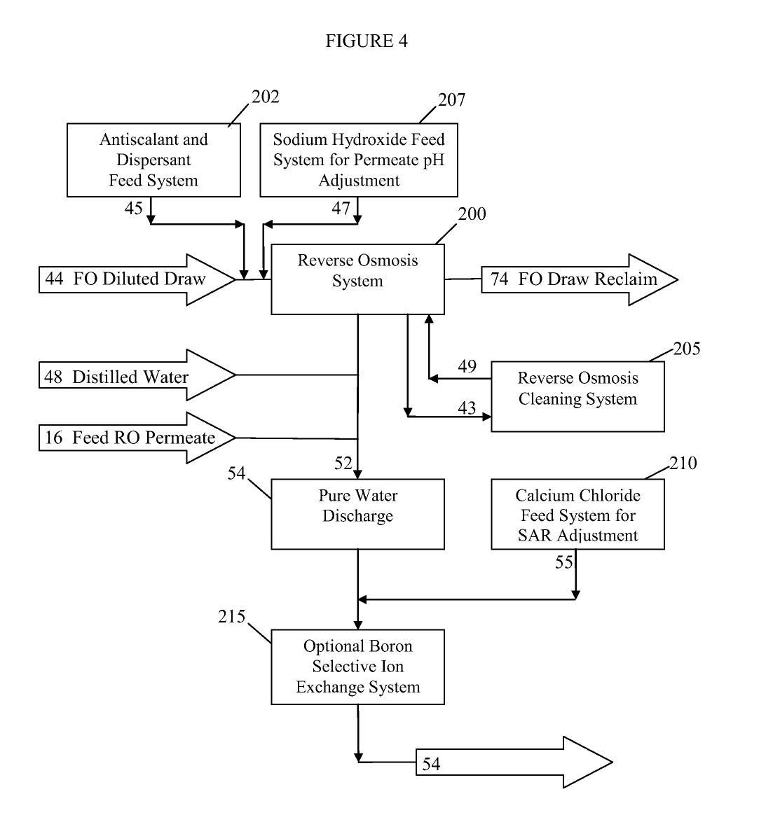

FIG. 4 illustrates a process for one embodiment of a dilute draw water reverse osmosis system 200, a shown in FIG. 1. The dilute draw water reverse osmosis system 200 may include an antiscalant and dispersant feed system 202 that meters an antiscalant and dispersant upstream of the reverse osmosis system, as shown at 45. It may further include a sodium hydroxide feed system 207 for permeate pH adjustment as depicted at 47 to aid in the control of boron and ammonium/ammonia concentrations to meet regulation requirements. The dilute draw solution reverse osmosis concentrate indicated at 74 is recycled back to the draw solution storage tank (FIG. 1; Item 180) while the dilute draw water reverse osmosis permeate 46 may be blended with the distilled water 48 from an evaporator and crystallizer 220 (as shown in FIG. 1) and permeate 16 from the concentrated feed water reverse osmosis system 140. In order to meet discharge and beneficial use requirements the pure water discharge indicated at 54 may require the addition of a calcium salt such as calcium chloride by including a calcium chloride feed system 210 for Sodium Adsorption Ratio (SAR) adjustments, as indicated at 55. The diluted draw water reverse osmosis system 200 may include a cleaning system 205 that can be shared with the concentrated feed water reverse osmosis system that permits the periodic cleaning of the reverse osmosis system 200 by feeding a cleaning solution as indicated at 49 that may be recirculated back to the cleaning system 205 as indicated at 43. The inclusion of a boron selective ion exchange system 215 as part the pure water discharge may be required in order to meet regulation requirements.

### Example I

A water treatment system as illustrated in FIG. 1 is designed. The system has been designed to treat a high saline produced water and flow back water at a design temperature between 45° F. and 90° F. with a normal performance design temperature of 70° F. The commercial system based on the assessed technologies (see Example II) is designed to have a high recovery of better than 95%. This recovery is further enhanced by the use of thermal evaporation and crystallization on a small liquid waste stream to provide for a near zero liquid discharge treatment process. This high recovery process includes reverse osmosis treatment of the concentrated impaired well water after lime soda softening for alkaline earth metals (calcium, magnesium, barium, strontium) removal and silica concentration reduction. Reverse osmosis concentrate from the treatment of the diluted draw solution would be recycled in a closed loop and blended with the forward osmosis draw solution.

A produced water 10,000 bbl (420,000 gallons) per day batch treatment system will require 54,000 bbl (2,268,000 gallons) per day of impaired (high sulfate concentration) well water and produce 60,800 bbl (2,553,600 gallons) per day of pure water having a water quality that meets and exceeds all North Dakota standards for irrigation water, livestock water, and drinking water after remineralization with calcium chloride to meet Sodium Adsorption Ratio (SAR) regulations. Table 1 shows the design water quality for a typical produced water and flow back water to be used as a draw solution for forward osmosis as well as a design water quality for an impaired well water to be used as a feed solution for forward osmosis for the invention method and system. The impaired well water has a design concentration of 1,300 mg/l of sulfate with a TDS of 4,160 mg/l. The North Dakota commonly accepted standard of sulfate concentration for drinking water is 250 mg/l with a TDS not to exceed 500 mg/l while the acceptable concentration of sulfates in irrigation and livestock water is less than 450 mg/l or 750 mg/l with a TDS guideline not to exceed 2,000 mg/l, although some water supplies in the state exceed even the guideline concentrations. Table 2 summarizes some of the key North Dakota drinking and irrigation water standards. Table 1 further shows the expected water quality after each major stage or step of the invention method and system including electrocoagulation with ultrafiltration, concentrated feed water reverse osmosis, diluted draw water reverse osmosis, and remineralization and treatment with boron selective ion exchange if required.

The high salinity produced water and flow back water will be treated at a flow rate of 700 gpm for 10 hours in a single electrocoagulation unit. Two (2) inclined tube settler clarifiers will treat the outfall from the electrocoagulation system at a flow rate of 350 gpm each. The clarifier effluent will be pumped to an ultrafiltration feed tank Four (4) 234 gpm filtrate each ultrafiltration banks are designed to treat the electrocoagulated water by feeding 1,200 gpm of feed water at 90 psig to each bank These ultrafiltration system banks will each provide 33% of the design flow required for the system. Electrocoagulation is an effective pretreatment for organics removal from oil field produced water. The technology when coupled with membrane filtration by ultrafiltration is designed to remove up to 100% of the following organic content of the produced water and flow back water as indicated in the third reporting column of Table 1:

| | | |
|---|---|---|
| Oil and Grease | 15 | mg/l |
| Recoverable Petroleum Hydrocarbons (TRPH) | 10 | mg/l |
| Gasoline Range Organics (C5-C12) (GRO) | 0.87 | mg/l |
| Diesel Range Organics (C8-C28) (DRO) | 6.2 | mg/l |
| Volatile Fatty Acids (C2-C5) (VFA) | 340 | mg/l |

The electrocoagulation and ultrafiltration system product water is collected at 700 gpm in a forward osmosis draw solution tank. This tank is also designed to collect concentrate from the diluted draw solution reverse osmosis system at a maximum design flow rate of 1,900 gpm with 475 gpm of concentrate flowing from each of four (4) 25% diluted draw solution reverse osmosis banks. After disc filtration at a removal rating of 100 microns or smaller, the impaired well water will be fed as feed water at 3,750 gpm to each of five (5) 25% forward osmosis banks while the draw water is fed at 600 gpm to each forward osmosis bank. The forward osmosis system will be run in a batch mode with approximately 10 hours per day required to dilute out the draw solution with the impaired well water feed solution. The batch process efficiency is maximized by controlling the blending and further treatment of the feed water during its concentration and the draw solution during its dilution in the forward osmosis process. The forward osmosis process is accomplished at a feed water pressure not to exceed 65 psig. Once a sufficient volume of forward osmosis feed water has been concentrated and forward osmosis draw solution diluted both streams are further treated.

The designed system treats the concentrated forward osmosis feed water with a single 40 foot diameter solids contact clarifier with a minimum 18 foot water wall in a 20 foot high vessel with a flow rate of 820 gpm. The solids contact clarifier outfall is further treated by three (3) 50% banks of hollow fiber ultrafiltration modules each bank designed to treat 410 gpm. Some of the ultrafiltration filtrate is collected for use for cleaning the ultrafiltration system while 760 gpm of the filtrate is treated by two (2) 380 gpm feed water reverse osmosis banks operating at 75 to 85% recovery. At 85% recovery 646 gpm of permeate of the quality shown in the fifth reporting column of Table 1 will be collected for eventual discharge as high purity water. At 85% recovery the 114 gpm concentrate stream can be further treated by an evaporator and crystallizer to provide for an overall system recovery exceeding 98%. The 114 gpm waste stream can be disposed of by deep well injection providing for an overall system recovery of 95% based on an impaired well water feed of 54,000 bbl (2,268,000 gallons) per day and produced water feed of 10,000 bbl (420,000 gallons) with a 60,800 bbl (2,553,600 gallons) per day production of high purity water for discharge and 3,200 bbl (134,400 gallons) per day waste volume.

The designed system treats the diluted forward osmosis draw water with four (4) 1,190 gpm feed reverse osmosis banks capable of producing up to 715 gpm of permeate per each bank, operating at a maximum recovery of 60%. The concentrate from the diluted forward osmosis draw reverse osmosis system will be recycled back to a forward osmosis draw water storage tank. The diluted forward osmosis draw reverse osmosis permeate water quality will be as shown in the fourth reporting column of Table 1. The sixth reporting column in Table 1 shows the expected high purity water quality of the blended reverse osmosis permeate from the diluted forward osmosis draw solution reverse osmosis system and the concentrated forward osmosis feed solution reverse osmosis system. The high purity water quality meets all of the drinking water and irrigation water key standards shown in Table 2 with the exception of boron and acceptable Sodium Adsorption Ratio (SAR). The designed remineralization of the high purity water with a calcium salt such as calcium chloride and the treatment of the high purity water with boron selective ion exchange will produce a discharge water quality that meets all of the Table 2 criteria as indicated in the seventh, far right reporting column of Table 1.

### Example II

Electrocoagulation testing of produced water and flow back water from shale oil operations in Western North Dakota with bench scale equipment capable of treating approximately 1.5 gpm was conducted. The oil field produced water and the hydraulic fracturing flow back water was characterized as being highly saline, having near saturated concentrations of sodium chloride, having an analysis similar to the second reporting column in Table 1. Also available for testing was an impaired shallow well water having brackish water salinity with a very high concentration of sulfates rendering it unsuitable for human consumption, livestock consumption, crop irrigation, or the make-up of fresh hydraulic fracturing water by oil production service companies in the area. The sulfate concentration in the impaired well water was characterized in general as being in the 1,000 to 2,000 ppm range with a water quality similar to the first reporting column of Table 1. Oil production service companies have discovered that it is unlikely that electrocoagulation alone would permit any of the produced water or hydraulic fracturing flow back water to be reused or recycled for any meaningful beneficial use. The current practice is to deep well inject the waste water usually after the produced water and hydraulic fracturing flow back water are blended. There is currently about one (1) injection well for every three (3) production wells to dispose of both the produced water and the hydraulic fracturing flow back water, although this may vary widely depending on the production techniques utilized. Further arrangements were made to conduct technology assessment testing of the oil field produced and hydraulic fracturing flow back water treating electrocoagulation system outfall employing membrane based ultrafiltration, forward osmosis, and seawater reverse osmosis. Equipment capable of treating 1.5 gpm of electrocoagulation outfall was designed and assembled. A technology assessment testing plan was developed to use impaired well water high in sulfate concentration as a feed solution or source of fresh water for the forward osmosis technology assessment. High saline produced water or hydraulic fracturing flow back water was planned to be used as an osmotic draw solution for the forward osmosis technology assessment. Once diluted with deionized water drawn from the impaired well water, the produced water with a reduced salinity was treated with the seawater reverse osmosis system to demonstrate the quality of water that could be obtained from the desalination technology.

The purpose of the technology assessment testing was to successfully demonstrate the following:
A. Electrocoagulation when coupled with membrane filtration by ultrafiltration is an effective pretreatment for organics removal, silica concentration reduction, free oil and grease removal, and suspended solids removal from oil field produced water.
B. Demonstrate that impaired well water can be used as a feed solution and high saline produced water that has been treated by electrocoagulation and ultrafiltration can be used as a draw solution for forward osmosis to reduce the concentration of the produced water to a point where it can be further treated and used as make-up for hydraulic fracturing water.
C. Demonstrate that seawater reverse osmosis can further treat forward osmosis diluted produced water to provide water of a quality that it can be discharged or be used for another beneficial use.
D. Provide some preliminary performance information for each technology evaluated to permit an economic assessment of its commercial value as an alternative to deep-well injection.

The current costs for fresh water, and produced water and hydraulic fracturing water disposal in the Williston Basin and Bakken formation areas of North Dakota and Montana have been identified by the University of North Dakota's Energy and Environmental Research Center as follows:

Water-Handling Costs, $/bbl

| Acquisition Costs | |
|---|---|
| Raw Water | $0.25-$1.05 |
| Transportation | $0.63-$5.00 |
| Disposal Costs | |
| Transportation | $0.63-$9.00 |
| Deep-Well Injection | $0.50-$1.75 |
| Total Costs | $2.00-$16.80 |

Despite the stated variability and wide range of costs disclosed by the University of North Dakota's Energy and Environmental Research Center, any water treatment technology or set of technologies used to provide recycled water for the make-up of hydraulic fracturing water or to treat all or some part of the produced water and hydraulic fracturing flow back water as an alternative to deep-well injection will have to be more economical than the stated costs. The hydraulic fracturing water flow back and produced water are blended in many current operations in an effort to partially dilute the high saline produced water for easier injection.

Fresh water for the make-up of hydraulic fracturing fluid is not readily available, as current practice does not permit the use of surface water from the Missouri River water system and municipal systems have exceeded many of their allocations for industrial use of the water by oil production and services companies. Additionally, many of the shallow aquifers contain impaired water that is too high in sulfate concentration for direct use by oil production and services companies and is considered impaired by its sulfate concentration and unable to be used as a potable water, livestock water, or irrigation water. The well studied Dakota Aquifer is available at 3,000 to 5,000 feet as an abundant source of water for industrial use by oil production and services companies. This water has been characterized as being warm at 150-160° F. although this will vary significantly from well to well and the sulfate concentration may similarly impair this water, and vary from well to well. For the North Dakota area, the problem is described as being due in part to a geology that is spatially variable and stratified, meaning a well can be drilled at 400 feet and produce a water that is high in sulfates, then a second well can be drilled 400 yards away and have a completely different chemistry with regards to sulfates. There are also reports that a high volume well from a higher aquifer can change in chemistry as it communicates with other high sulfate pockets. See, e.g., Maianu, A. Natural Conditions of Salt Accumulation in North Dakota, North Dakota Farm Research, Volume 43, No. 6, 9-11, 20, May-Jun., 1986; Bachu and Hitchon, Regional-Scale Floe of Formation Waters in the Williston Basin, AAPG Bulletin, Volume 80, No. 2 248-264, February 1996; Schuh, et al., Sources and Processes Affecting the Distribution of Dissolved Sulfate in the Elk Valley Aquifer in Grand Forks County, Eastern North Dakota, Water Resources Investigation No. 38 North Dakota Sate Water Commission Bismarck, N. Dak. 2006; and the Energy & Environmental Research Center (EERC) Report entitled: Bakken Water Opportunities Assessment—Phase 1, prepared by Stepan, et al of the EERC in April 2010 and available from the National Technical Service, US Dept. of Commerce; the contents of each of which are incorporated by reference herein in their entireties.

Additional research has been conducted to better characterize the water expected from the Dakota aquifer. The groundwater system has been thoroughly studied and most of the detailed research is from a number of years ago, a better part of it performed by Canadian academics. One paper authored by a group out of the North Dakota State University entitled “Salt Accumulation in the Groundwater of North Dakota” (Maianu et al, North Dakota Farm Research; Volume 45, No. 2, 12-18, Sep.-Oct., 1987, the contents of which are incorporated by reference herein in its entirety) shows as Group 8 in Table 2 report results from the Dakota Aquifer (AQ4). There is a great deal of variability in the reported results summarized as follows:

| | | | | |
|---|---|---|---|---|
| Calcium (ppm as Ca++) | 96.2 | ppm Mean | 1,200.4 | ppm Maximum |
| Magnesium (ppm as Mg++) | 36.5 | ppm Mean | 441.1 | ppm Maximum |
| Sodium (ppm as Na+) | 1,094.3 | ppm Mean | 9,195.9 | ppm Maximum |
| Potassium (ppm as K+) | 23.5 | ppm Mean | 258.1 | ppm Maximum |
| Bicarbonate (ppm as HCO3−) | 427.1 | ppm Mean | 2,123.4 | ppm Maximum |
| Chloride (ppm as Cl−) | 1,003.3 | ppm Mean | 15,996.4 | ppm Maximum |
| Sulfate (ppm as SO4−−) | 1,042.3 | Mean | 2,401.5 | ppm Maximum |
| Conductivity (μS/cm) | 5,200 | μS/cm Mean | 58,000 | μS/cm Maximum |
| TDS Calculated (ppm) | 3,333 | ppm Mean | 37,100 | ppm Maximum |

The electrocoagulation system was designed to treat 1.5 gpm of water and was tested with a conical bottomed tank used to collect the outfall from the electrocoagulation system. The produced water was treated at 12.5 VDC and 15 amps. The system was equipped with 42 cold rolled carbon steel blades each 8″ wide by 9″ long by 0.125″ thick. Five of the blades were power blades to which an electrical current can be attached that permits three different chamber configurations to be used, single (first and last), two (2) chambers, and four (4) chambers. The treatment during the technology assessment was with a single chamber or with two (2) chambers. The standard iron usage for steel plates provided by the manufacturer, was about 0.20 pounds per 1,000 gallons of water treated. Based on the provided performance information, the projected cost to perform electrocoagulation on the produced water is $0.0054 per barrel. This is based on an estimated industrial electrical cost of $0.0620 per kw-hr. Based on the testing electrocoagulation is an effective pretreatment for organics removal from oil field produced water. The produced water was treated by electrocoagulation without chemical addition. The electrocoagulation technology when coupled with membrane filtration by ultrafiltration was able to remove 100% of the following organic content of the produced water as shown in the third reporting column of Table 1:

| | | |
|---|---|---|
| Oil and Grease | 15 | mg/l |
| Recoverable Petroleum Hydrocarbons (TRPH) | 10 | mg/l |
| Gasoline Range Organics (C5-C12) (GRO) | 0.87 | mg/l |
| Diesel Range Organics (C8-C28) (DRO) | 6.2 | mg/l |
| Volatile Fatty Acids (C2-C5) (VFA) | 340 | mg/l |

The ultrafiltration membrane tested was provided by Hydration Technology Innovations, LLC and is their Model SepraMem 4040UF-CS with 100 mil corrugated spacer. This membrane has a proprietary composition identified by the manufacturer as regenerated cellulose or a hydrolyzed cellulose ester blend. The provided membrane has 1.5 square meters or 16 square feet of membrane surface area. The rated flow rate provided from the manufacturer was 0.67 gpm of permeate or an operating flux rate of 60.3 gfd with a cross flow of 20 gpm at 65 psig. The process was operated based on the membrane manufacturer's recommendation with 20 gpm of cross flow feed at 65 psig. The original tests using testing facility water at 65 psig provided a flow rate of only 0.03 gpm of filtrate. The final production step of hydrolyzing the membranes had not been done according to communication with the membrane manufacturer. After hydrolysis of the membrane in the field the flow rate of filtrate increased to 0.284 gpm or an operated flux of 25.6 gfd when treating the produced water. The permeate temperature climbed from 14.3° C. (57.7° F.) to 25° C. (77° F.) during the filtration process. The filtrate flow increased to 0.328 gpm or an operating flux of 29.52 gfd with the temperature increase. The flow rates and operating pressures remained constant during the ultrafiltration of the produced water. The total filtration time without cleaning was nearly 12 hours implying that there was not significant fouling occurring with the use of the membrane tested. Based on the membrane design conditions, testing conditions, and considering electrical costs, cleaning costs, concentrate disposal costs, and membrane replacement cost, the projected cost to treat the electrocoagulation outfall by ultrafiltration is $0.1705 per barrel to no more than $0.3210 per barrel.

The forward osmosis membrane tested was provided by Hydration Technology Innovations, LLC and is their Model OsMem 4040FO-MS with 45 mil screen style spacer. This membrane has a cellulose triacetate composition. The tested membrane has 3.2 square meters or 32 square feet of membrane surface area. The flow rates tested were 0.4 gpm of draw solution at nine (9) psig with a feed water flow of 10 gpm at 19 psig. A Hydration Technology Innovations, LLC Model OsMem 4040FO-CS with 100 mil corrugated spacer was available but not tested. The draw solution pressure drop during testing was 7 psig. The feed solution pressure drop during testing was 5 psig. These observed values are consistent with the manufacturer's performance criteria for the forward osmosis membrane tested. The flow rates and operating pressures remained constant during the forward osmosis treatment. The total process testing time was nearly eight (8) hours implying that there was no catastrophic fouling occurring with the use of the tested forward osmosis membrane. Hydration Technology Innovations, LLC, the forward osmosis membrane manufacturer, was contacted and provided an indication of the dilute out process performance. The performance appeared to be normal based on the membrane used and the process tested. The performance does not indicate any degree of fouling during the process testing period according to Hydration Technology Innovations, LLC. The conductivity of the feed solution and draw solution were measured hourly during the membrane manufacturer's dilute out batch process. It is the diluted draw water sample that became the feed water for the reverse osmosis. Based on the membrane testing conditions and considering electrical costs, cleaning costs, and membrane replacement cost, the projected cost to treat the filtered produced water by forward osmosis is between $0.2979 per barrel and $1.0864 per barrel based on the dilute out process tested. The conductivity of the draw solution decreased from 220,000 μmhos/cm to 102,500 μmhos/cm during the first 90 minutes of the dilute out mode of operation tested then tapered off by steadily declining at a slower rate to 74,500 μmhos/cm after around eight (8) hours. This final conductivity of the draw solution was determined in the field to be equivalent to a TDS of 37,000 ppm as the forward osmosis testing was ended and reverse osmosis was employed to further treat the diluted draw solution. The feed solution conductivity increased from 4,470 μmhos/cm to 10,580 μmhos/cm over the course of the forward osmosis testing. Provisions were planned for use of a stronger concentration draw solution or osmolyte such as magnesium chloride if required, but this was not necessary during the technology assessment testing.

A small seawater reverse osmosis system kit capable of producing 20 gph of permeate at 8% recovery was purchased from Cruise RO Water of Escondido, Calif. The seawater reverse osmosis system was assembled on an assembly skid with the forward osmosis system. The seawater reverse osmosis membrane tested was a Dow Filmtec Model SW30-2540. This membrane is a polyamide thin film composite product that has a rated maximum operating pressure of 1,000 psig and a rated salt rejection of 99.4% based on treating 32,000 ppm of sodium chloride at 800 psig, 77° F. (25° C.) and at a per element recovery rate of 8%. The membrane has an active surface area of 2.7 square meters or 29 square feet. The system was set up to produce 0.33 gpm of permeate while treating 4.17 gpm of feed water. The reverse osmosis system was used to demonstrate the treatment of diluted produced water after electrocoagulation, ultrafiltration, and forward osmosis. Reverse osmosis at 950 psig was able to remove 96.9% of the sodium concentration in the water and 97.2% of the chloride concentration while removing 97.0% of the TDS. The projected cost considering electrical cost, cleaning cost, antiscalant feed cost, and membrane replacement cost to treat the diluted produced water after forward osmosis by reverse osmosis based on the conditions tested is $0.0717 per barrel.

Using an impaired well water as a feed solution and high saline produced water as a draw solution forward osmosis coupled with reverse osmosis was successfully demonstrated to produce high purity water with the following concentration reductions from the high saline produced water:

| | |
|---|---|
| Calcium | 99.82% |
| Magnesium | 99.79% |
| Sodium | 99.51% |
| Potassium | 99.47% |
| Barium | 94.95% |
| Strontium | 99.83% |
| Chloride | 99.55% |
| TOC | 97.84% |
| COD | 99.54% |
| Ammonium | 99.09% |
| Boron | 96.47% |
| Conductivity | 99.50% |
| TDS | 99.47% |
| TSS | 100% |

Based on the maximum projected costs the treatment process could be evaluated by an oil production company or a service company as being an economically viable alternative to treatment by deep-well injection or thermal evaporation. Based on the testing conditions the projected maximum costs to treat high saline produced water by the technologies demonstrated are as follows:

| Electrocoagulation | $0.0054/bbl |
|---|---|
| Ultrafiltration | $0.1705-$0.3210/bbl |
| Forward Osmosis | $0.2979-$1.0864 |
| Reverse Osmosis | $0.0717 |
| Total | $0.5455-$1.4845 |

All references, including publications, patents, and patent applications, cited herein are hereby incorporated by reference to the same extent as if each reference were individually and specifically indicated to be incorporated by reference and were set forth in its entirety herein.

While the present disclosure has been described in certain embodiments, the teaching of this disclosure can be further modified within the spirit and scope of this present invention. This application is therefore intended to cover any variations, uses, or adaptations of the disclosure using its general principles. Further, this application is intended to cover such departures from the present disclosure as come within known or customary practice in the art to which this invention pertains and which fall within the limits of the appended claims.

TABLE 1
FORWARD OSMOSIS AND REVERSE OSMOSIS PERFORMANCE WATER QUALITY SUMMARY

| | IMPAIRED | PRODUCED | PRODUCED | FO DRAW |
|---|---|---|---|---|
| | WELL WATER | AND FLOW | WATER AFTER | WATER RO |
| PARAMETER | FO FEED | BACK WATER | EC AND UF | PERMEATE |
| CALCIUM, PPM AS Ca | 117 | 12,000 | 9,430 | 1.770 |
| MAGNESIUM, PPM AS Mg | 39.3 | 1,350 | 1,080 | 0.202 |
| TOTAL HARDNESS, PPM AS CaCO₃ | 454.4 | 35,562 | 28,026.1 | 5.26 |
| SODIUM, PPM AS Na | 799 | 98,000 | 89,000 | 90.69 |
| POTASSIUM, PPM AS K | 16.3 | 5,910 | 4,760 | 4.37 |
| BARIUM, PPM AS Ba | 0.015 | 0.811 | 0.642 | 0.00 |
| STRONTIUM, PPM AS Sr | 1.33 | 794 | 641 | 0.116 |
| IRON, PPM AS Fe | 4.56 | 0 | 0 | 0.0 |
| MANGANESE, PPM AS Mn | 0.210 | 0 | 0.625 | 0.0 |
| ALKALINITY, PPM AS HCO₃ | 837.0 | 65.0 | 611 | 3.63 |
| ALKALINITY, PPM AS CO₃ | 0.0 | 0.0 | 0.0 | 0.161 |
| ALKALINITY, PPM AS OH | 0.0 | 0.0 | 0.0 | 0.0 |
| CHLORIDE, PPM AS Cl | 300 | 190,000 | 165,000 | 147.2 |
| SULFATE, PPM AS SO₄ | 1,300 | 0 | 0 | 0.09 |
| SILICA DISSOLVED, PPM AS SiO₂ | 28.1 | 0.2 | 0.03 | 0.09 |
| SILICA TOTAL, PPM AS SiO₂ | 28.1 | 0.2 | 0.08 | 0.09 |
| TOC, PPM AS C | 904 | 954 | 497 | 2 |
| COD, PPM AS COD | 3,110 | 17,000 | 16,300 | 4 |
| TRUE COLOR, Pt—Co UNITS | 80 | 5 | 10 | 2 |
| AMMONIUM, PPM AS N—NH₄ | 0 | 1,826 | 1,595 | 1.03 |
| CARBON DIOXIDE, PPM AS CO₂ | 26.4 | 266.5 | 38.5 | 0.13 |
| BORON, PPM AS B | 0.59 | 168 | 287 | 2.127 |
| pH | 7.7 | 5.6 | 7.4 | 7.7 |
| ORP, mV | 6 | −18 | −2 | 30 |
| CONDUCTIVITY, μMHOS/CM | 3,760 | 584,000 | 523,000 | 393 |
| TURBIDITY, NTU's | 4.80 | 21.7 | 0.62 | 0.0 |
| TDS, PPM | 4,160 | 318,000 | 276,000 | 251.5 |
| TSS, PPM | 22 | 689 | 20 | 0.0 |
| SPECIFIC GRAVITY, GM/ML | 0.99 | 1.17 | 1.16 | 0.99 |
| OIL AND GREASE (HEM), PPM | 0 | 15 | 0 | 0 |
| TRPH (SGT-HEM), PPM | 0 | 10 | 0 | 0 |
| GASOLINE RANGE ORGANICS, PPM | 0 | 0.87 | 0 | 0 |
| DIESEL RANGE ORGANICS, PPM | 0 | 6.2 | 0 | 0 |
| TOTAL VOLATILE FATTY ACIDS, PPM | 0 | 340 | 0 | 0 |
| ACETIC ACID, PPM | 0 | 57 | 0 | 0 |
| BUTYRIC ACID, PPM | 0 | 140 | 0 | 0 |
| PROPIONIC ACID, PPM | 0 | 65 | 0 | 0 |
| VALERIC ACID, PPM | 0 | 78 | 0 | 0 |
| ACETONE, PPM | 0 | 0.067 | 0.631 | 0 |
| BENZENE, PPM | 0 | 0.274 | 0 | 0 |
| TOLUENE, PPM | 0 | 0.020 | 0 | 0 |
| ISOBUTANOL, PPM | 0 | 0 | 0 | 0 |
| N-BUTYL ALCOHOL, PPM | 0 | 0 | 0 | 0 |
| XYLENES, PPM | 0 | 0 | 0 | 0 |
| CYCLOHEXANONE, PPM | 0 | 0 | 0.157 | 0 |
| METHYL ETHYL KETONE (MEK), PPM | 0 | 0 | 0.296 | 0 |
| SODIUM ADSORPTION RATIO (SAR) | 16.3 | 225.8 | 230.0 | 17.2 |

| | FO FEED | COMBINED | DISCHARGE |
|---|---|---|---|
| | WATER RO | TREATED | AFTER BORON |
| PARAMETER | PERMEATE | WATER | REMOVAL |
| CALCIUM, PPM AS Ca | 0.02 | 1.34 | 17.34 |
| MAGNESIUM, PPM AS Mg | 0.00 | 0.15 | 0.15 |
| TOTAL HARDNESS, PPM AS CaCO₃ | 0.05 | 3.97 | 59.71 |
| SODIUM, PPM AS Na | 38.63 | 76.61 | 76.61 |
| POTASSIUM, PPM AS K | 1.91 | 3.71 | 3.71 |
| BARIUM, PPM AS Ba | 0.00 | 0.00 | 0.00 |
| STRONTIUM, PPM AS Sr | 0.00 | 0.085 | 0.085 |
| IRON, PPM AS Fe | 0.0 | 0.0 | 0.0 |
| MANGANESE, PPM AS Mn | 0.0 | 0.0 | 0.0 |
| ALKALINITY, PPM AS HCO₃ | 22.14 | 8.60 | 8.60 |
| ALKALINITY, PPM AS CO₃ | 2.03 | 0.66 | 0.66 |
| ALKALINITY, PPM AS OH | 0.0 | 0.0 | 0.0 |
| CHLORIDE, PPM AS Cl | 28.29 | 115.3 | 143.7 |
| SULFATE, PPM AS SO₄ | 21.67 | 5.88 | 5.88 |
| SILICA DISSOLVED, PPM AS SiO₂ | 0.76 | 0.27 | 0.27 |
| SILICA TOTAL, PPM AS SiO₂ | 0.76 | 0.27 | 0.27 |
| TOC, PPM AS C | 2 | 2 | 2 |
| COD, PPM AS COD | 4 | 4 | 4 |
| TRUE COLOR, Pt—Co UNITS | 1 | 1 | 1 |
| AMMONIUM, PPM AS N—NH₄ | 0.0 | 0.75 | 0.75 |
| CARBON DIOXIDE, PPM AS CO₂ | 0.02 | 0.10 | 0.10 |
| BORON, PPM AS B | 0.85 | 1.78 | 0.30 |
| pH | 9.2 | 7.9 | 7.9 |
| ORP, mV | 30 | 30 | 41 |
| CONDUCTIVITY, μMHOS/CM | 190 | 338 | 408 |
| TURBIDITY, NTU's | 0.0 | 0.0 | 0.0 |
| TDS, PPM | 120.61 | 216.4 | 260.8 |
| TSS, PPM | 0.0 | 0.0 | 0.0 |
| SPECIFIC GRAVITY, GM/ML | 0.99 | 0.99 | 0.99 |
| OIL AND GREASE (HEM), PPM | 0 | 0 | 0 |
| TRPH (SGT-HEM), PPM | 0 | 0 | 0 |
| GASOLINE RANGE ORGANICS, PPM | 0 | 0 | 0 |
| DIESEL RANGE ORGANICS, PPM | 0 | 0 | 0 |
| TOTAL VOLATILE FATTY ACIDS, PPM | 0 | 0 | 0 |
| ACETIC ACID, PPM | 0 | 0 | 0 |
| BUTYRIC ACID, PPM | 0 | 0 | 0 |
| PROPIONIC ACID, PPM | 0 | 0 | 0 |
| VALERIC ACID, PPM | 0 | 0 | 0 |
| ACETONE, PPM | 0 | 0 | 0 |
| BENZENE, PPM | 0 | 0 | 0 |
| TOLUENE, PPM | 0 | 0 | 0 |
| ISOBUTANOL, PPM | 0 | 0 | 0 |
| N-BUTYL ALCOHOL, PPM | 0 | 0 | 0 |
| XYLENES, PPM | 0 | 0 | 0 |
| CYCLOHEXANONE, PPM | 0 | 0 | 0 |
| METHYL ETHYL KETONE (MEK), PPM | 0 | 0 | 0 |
| SODIUM ADSORPTION RATIO (SAR) | 75.1 | 16.7 | 5.0 |

TABLE 2
SUMMARY OF NORTH DAKOTA KEY DRINKING
AND IRRIGATION WATER STANDARDS

| | | IRRIGATION | IRRIGATION |
|---|---|---|---|
| | DRINKING | WATER | WATER |
| PARAMETER | WATER | CLASS II | CLASS III |
| pH | 6.5-8.5 | 6.0-9.0 | 6.0-9.0 |
| BORON, PPM AS B | 0.750 | 0.500-0.750 | 0.500-0.750 |
| CHLORIDE, PPM AS Cl | 250 | 250 | 250 |
| SODIUM, PPM AS Na | 100 | N/A | N/A |
| SULFATE, PPM AS SO₄ | 250 | 450 | 750 |
| LEAD, PPM AS Pb | 0.015 | 0.010 | 0.010 |
| COPPER, PPM AS Cu | 1.000 | 1.000 | 1.000 |
| CYANIDE, PPM AS CN | 0.140 | 0.140 | 0.140 |
| ARSENIC, PPM AS As | 0.010 | 0.010 | 0.010 |
| MERCURY, PPM AS Hg | 0.00005 | 0.00005 | 0.00005 |
| ZINC, PPM AS Zn | 5.000 | 0.120 | 0.120 |
| CHROMIUM, PPM AS Cr (III) TOTAL | 0.100 | 0.100 | 0.100 |
| CHROMIUM, PPM AS Cr (VI) TOTAL | 0.100 | 0.100 | 0.100 |
| NITRATES, PPM AS NO₃ | 1.0 | 1.0 | 1.0 |
| AMMONIA, PPM AS N—NH₃ | 8.4 | 8.4 | 8.4 |
| (CALCULATED) | | | |
| TDS, PPM (GUIDE ONLY) | 500 | 2,000 | 2,000 |
| ALUMINUM, PPM AS Al | 0.200 | 0.750 | 0.750 |
| COLIFORMS (E-COLI), CFU/100 ML | NONE | <126 | <126 |

What is claimed is:

1. A method of treating an aqueous high salinity liquid containing suspended solids, colloidal solids, free oil and grease, dissolved minerals, and dissolved hydrocarbons, the method comprising:
passing an aqueous liquid containing suspended solids, colloidal solids, free oil and grease, dissolved minerals, and dissolved hydrocarbons through an electrocoagulation system at an unadjusted pH;
passing the effluent from the electrocoagulation system through an inclined plate, inclined tube, or solids contact clarifier;
passing the clarifier outfall through an ultrafiltration system; and
using the ultrafiltration filtrate as a high salinity draw solution for forward osmosis, the draw solution being diluted by deionized water drawn across a semi-permeable forward osmosis membrane by use of an impaired water as feed to the forward osmosis system prior to contacting a dilute draw water reverse osmosis system.

2. The method according to claim 1, wherein the impaired water used as feed to the forward osmosis system has a sulfate concentration of at least about 1,000 ppm.

3. The method according to claim 2, wherein the impaired water used as feed to the forward osmosis system has a sulfate concentration of at least about 1,300 ppm.

4. The method according to claim 2, further comprising treatment of concentrated feed water after forward osmosis with a lime soda softener in fluid communication with a concentrated feed water ultrafiltration system prior to contacting a high recovery concentrated feed water reverse osmosis system.

5. The method according to claim 4, wherein treatment of the concentrated feed water after forward osmosis with a lime soda softener in fluid communication with a concentrated feed water ultrafiltration system comprises treatment of concentrated feed water lime soda precipitation softener outfall with an ultrafiltration system comprising an outside-to-inside, near dead end, hollow fiber ultrafiltration membrane module.

6. The method according to claim 3, further comprising recycling at least a part of a precipitate sludge produced by the lime soda softener back into the lime soda softener.

7. The method according to claim 2, further comprising blending a permeate from the dilute draw water reverse osmosis system with the permeate from the concentrated feed water reverse osmosis system to produce a combined treated water requiring pH adjustment prior to the dilute draw water reverse osmosis system to give a final permeate pH between about 6.0 and about 9.0.

8. The method according to claim 7, further comprising remineralization of the water with the addition of a calcium salt such as calcium chloride as required to give a Sodium Adsorption Ratio (SAR) of less than about 6.

9. The method according to claim 7, further comprising passing the combined treated water through a boron selective ion exchange system to lower the boron concentration as required to acceptable concentrations.

10. The method according to claim 9, further comprising producing a discharge water having a sulfate concentration of less than about 450 ppm.

11. The method according to claim 1, wherein passing the clarifier outfall through an ultrafiltration system comprises passing the clarifier outflow through an ultrafiltration system comprising a spiral wound, fouling resistant, cross flow hydrophilic membrane with corrugated feed spacer.

12. The method according to claim 1, further comprising recycling a concentrate from the dilute draw reverse osmosis system for use in the forward osmosis draw solution.

13. The method according to claim 1, further comprising treating a concentrate from the reverse osmosis system with an evaporator and crystallizer to create a very near liquid zero discharge, and collecting a distillate from the evaporator and crystallizer as pure water for discharge.

14. A waste water treatment system for a high saline waste water feed stream, the system comprising:
an electrocoagulation system in fluid communication with a high saline waste water feed stream, the electrocoagulation system comprising a reaction basin with a set of vertically arranged reaction plates that are spaced apart and an electrical voltage is applied to selected members of the set of vertically arranged reaction plates by placing the selected members of the set of vertically arranged reaction plates in electrical contact with a voltage source to thereby create an electrical field within the reaction basin, and the treatment of the high saline waste water feed stream in the reaction basin takes place at unadjusted pH;
a clarifier in fluid communication with the electrocoagulation system, further feeding an ultrafiltration feed tank;
an ultrafiltration system in fluid communication with the ultrafiltration feed tank;
a forward osmosis draw solution tank in fluid communication with the filtrate from the ultrafiltration system;
a forward osmosis system in fluid communication with an impaired water used as a feed solution and the draw solution fed from the draw solution feed tank;
a forward osmosis dilute draw water reverse osmosis system in fluid communication with the forward osmosis draw solution feed tank;
a lime soda softener system in fluid communication with the forward osmosis concentrated feed water storage tank, comprising a lime and soda precipitation softener vessel;
a sludge storage tank in fluid communication with the lime and soda precipitation softener vessel, wherein contacting the forward osmosis concentrated feed water with lime and sodium carbonate (soda ash) in the lime and soda precipitation softener vessel produces a particulate suspension that settles to produce a sludge that is recycled back to the lime addition tank in fluid communication with the inlet alkalization tank prior to the lime and soda precipitation softener vessel;
a forward osmosis concentrated feed water ultrafiltration system in fluid communication with the lime and soda precipitation softener vessel;
a forward osmosis concentrated feed water reverse osmosis system in fluid communication with the forward osmosis feed water ultrafiltration system; and
a pure water discharge system in fluid combination with both reverse osmosis systems, wherein the combined high purity water may be subject to remineralization by the addition of a calcium salt such as calcium chloride in order to meet a Sodium Adsorption Ration (SAR) less than 6.

15. The system of claim 14, wherein the electrocoagulation system comprising a reaction basin with a set of vertically arranged reaction plates that are spaced apart and an electrical voltage is applied to selected members of the set of vertically arranged reaction plates by placing the selected members of the set of vertically arranged reaction plates in electrical contact with a voltage source to thereby create an electrical field within the reaction basin further comprises a system wherein the voltage and amperage of the electrical field is adjustable by varying the selected members of the vertically arranged reaction plates that are in electrical contact with the voltage source.

16. The system of claim 14, wherein the clarifier comprises an inclined plate, and inclined tube, or solids contact clarifier.

17. The system of claim 14, wherein the lime soda softener system in fluid communication with the forward osmosis concentrated feed water storage tank further comprises a lime silo, lime slaker, and lime feed system; and a sodium carbonate (soda ash) silo and feed system in fluid communication with the lime and soda precipitation softener vessel.

18. The system of claim 14, further comprising a sodium hydroxide feed ahead of the diluted draw solution reverse osmosis system for adjustment of pH to give a final combined high purity water pH between 6.0 and 9.0.

19. The system of claim 14, further comprising a boron specific ion exchange system for reducing the boron concentration of the final combined high purity water.

20. The system of claim 14, wherein the concentrate from the diluted forward osmosis draw solution reverse osmosis system is recycled back to the forward osmosis draw solution storage tank.

21. The system of claim 14, further comprising an evaporator and crystallizer in fluid communication with the concentrate from the concentrated forward osmosis feed solution reverse osmosis system which treats the concentrate to create a very near liquid zero discharge for processing in a sludge handling and solids discharge system, and a distillate of pure water for discharge.
